(19) United States
(12) Patent Application Publication
(10) Pub. No.: US 2021/0129099 A1
(43) Pub. Date: May 6, 2021

(54) DEVICE FOR MIXING AND SUPPLYING LIQUID

(71) Applicant: C&G HI TECH CO., LTD., Anseong (KR)

(72) Inventors: Yeon Beom LEE, Seoul (KR); Teg Kyu LIM, Pyeongtaek (KR); Kune Bok LIM, Pyeongtaek (KR); Ho Joon CHO, Osan (KR); Sung Soo KIM, Osan (KR); Choul Su AN, Anseong (KR); Chul Young KIM, Yangpyeong-gun (KR); Seung Hwa YANG, Hwaseong (KR)

(73) Assignee: C&G HI TECH CO., LTD., Anseong (KR)

(21) Appl. No.: 17/259,755

(22) PCT Filed: Jul. 4, 2019
(86) PCT No.: PCT/KR2019/008183

§ 371 Date: Jan. 12, 2021

(30) Foreign Application Priority Data
Jul. 13, 2018 (KR) 10-2018-0081393

(51) Int. Cl. B01F 15/02; B01F 3/08

(52) U.S. Cl. CPC B01F 15/0283; B01F 3/0803

(57) ABSTRACT

The present invention: continuously measures pressure in real time by means of pressure detection sensors inside a vessel and inside chemical piping and quickly discharges air when abnormal pressure is generated, so as to stably supply a crude liquid through a fixed pressure-maintaining liquid supply part; checks a standard concentration after the crude liquid is mixed so as to re-transfer the mixed liquid to a mixing tank unit when the concentration thereof does not reach the reference concentration, thereby spraying the mixed liquid through a jet nozzle member; and shortens the mixing time of primarily mixed liquid so as to enable the mixed liquid to be mass-produced and a stable quality thereof to be ensured.

### BACKGROUND OF THE DISCLOSURE

### Field of the Disclosure

The present invention relates to a device for mixing and supplying liquid and, more particularly, to a device 1 for mixing and supplying liquid which mixes a plurality of crude liquids having chemical components to obtain a mixed liquid and supplies the mixed liquid to a designated process, the device for mixing and supplying liquid including: crude liquid storage tank units 200 which each store the plurality of crude liquids; fixed pressure-maintaining liquid supply parts 100 which selectively supply the crude liquids to a mixing device unit 300 in a state that each of the crude liquids transferred from each of the crude liquid storage tank units 200 is maintained to a predetermined pressure; the mixing device unit 300 which mixes the plurality of crude liquids supplied from the fixed pressure-maintaining liquid supply parts 100; a mixing tank unit 400 which stores a mixed liquid transferred from the mixing device unit 300; a concentration checking unit 500 which checks the concentration amount of a liquid transferred from the mixing tank unit 400; a discharge line unit 600 which discharges a mixed liquid satisfying a preset concentration amount through the concentration checking unit 500; and a circulation line unit 700 which re-transfers a mixed liquid that does not satisfy the preset concentration amount through the concentration checking unit 500 to the mixing tank unit 400.

### Related Art

In general, a device for supplying liquid in various industrial site manufacturing lines of a semiconductor process, an LCD process, a pharmaceutical manufacturing process, and the like has been using combinations of a pressure regulator, a differential pressure flowmeter, and various sensors in addition to a pumping device so as to stabilize supply pressure when material supply pressure is instable and too high, and to implement a precise dispensing operation by the decompression effect.

Such a liquid pressure regulator, as a device maintaining a predetermined outlet pressure under conditions that a supply pressure of liquid is variously changed when decompressing a liquid discharged at a high pressure from a pump and supplying the decompressed liquid to pump at an appropriate pressure to discharge the liquid, is equipment which is positively necessary in order to operate countless equipment safely. It is preferable to select a product that is the most suitable for an operation desired by a user as the pressure regulator. At this time, important considerations include types, material, inlet and outlet pressures, flow amount condition, temperature, pressure, size, and other limitations.

Meanwhile, the differential pressure flowmeter has a simple structure, can be applied to any of liquid, gas, or vapor, and has long been widely used as an industrial flowmeter. A basic configuration of the differential pressure flowmeter consists of a tightening mechanism and a differential pressure detector, a pressure difference is generated between the front and rear of the tightening mechanism by a resistance generated in the tightening mechanism when installing the tightening mechanism in the middle of a pipe conduit through which a fluid flows, thereby reducing the passing area of the fluid, and a regular relational expression capable of being expressed by Bernoulli's principle is between the pressure difference, i.e., a differential pressure, and a flow amount. A flowmeter using the principle is the differential pressure flowmeter. Typical examples of a differential pressure-generating sensor include a venturi tube, an orifice, a flow nozzle, a V-cone, and the like, the differential pressure detectors may be largely divided into pneumatic differential pressure detectors, electronic differential pressure detectors, and optical differential pressure detectors depending on the transmission method and the measurement principle, and the electronic differential pressure detectors are currently a main type of the differential pressure detectors.

Meanwhile, a “method of producing or supplying liquid products (Korean Patent Laid-Open Publication No. 10-2014-0090639)” of the patent document 1 below is disclosed as a liquid supplying device which has being implemented.

The “method of producing or supplying liquid products” of the patent document 1 is a method of producing or supplying the liquid products by using a membrane contactor including a gas port which uses a plurality of gas permeable hollow fibers and is communicated with the inside of the fibers to dissolve a gas containing carbon dioxide or nitrous oxide in liquid, and liquid input and output ports which are communicated with an internal space of the contactor surrounding the fibers, the method comprising: a step of supplying the gas to the gas port at a controlled pressure; a step of supplying liquid from the liquid supply unit to the liquid input port at a pressure higher than that of the gas through a first valve including a first valve inlet port communicating with a liquid supply unit and a first valve outlet port communicating with the liquid inlet port; a step of supplying liquid having the gas dissolved therein from the liquid output port to the periphery thereof through a supply tap, the step of supplying liquid comprising a supply initiating step in which supply is initiated and a supply discontinuing step in which supply is discontinued, and the first valve being opened along with the supply tap in the supply initiating step and shut off in the supply discontinuing step; and a step of allowing the first valve to communicate with the space to release a pressure rise of the liquid while the first valve is being maintained in a shutoff state after the first valve is shut off. Therefore, the “method of producing or supplying liquid products” is capable of preventing the fibers from being immersed when there is not a requirement for liquid to flow, and allows a liquid pressure higher than an applied gas pressure to be applied for a short period of time when the liquid is supplied. This has not a long-term effect on the membrane and has an advantage of preventing carbonated liquid from being oversaturated in a tube between the contactor and the supply tap.

However, in the “method of producing or supplying liquid products” of the patent document 1, as a method of allowing mainly liquid to be directly supplied from a main supply pipe, there have been problems of deteriorating liquid production and supply amounts and qualities of subsequent processes as there have been many irregular changes in the liquid supply amount due to pressure changes including pressure rising and pressure reduction in supply of a main liquid, or a change in main supply pressures when using several equipment simultaneously connected to a main pipe.

### SUMMARY

The present invention has been conceived to solve the aforementioned problems, the present invention provides a device for mixing and supplying liquid which is operated so that a predetermined fixed pressure of a final supply stage is maintained despite the changing pressure due to an external influence of the main supply pressure to enable a very stable mixed liquid to be supplied, and which increases the operation rate of equipment to increase an output and improve quality by installing a main nitrogen (N2) gas supply means and a pressure fine-tuning nitrogen (N2) gas pressurization means on a vessel containing a liquid supplied at a variable liquid supply pressure and forming a fixed pressure-maintaining liquid supply part which controls the operation by monitoring pressure inside the vessel in real time in the configuration of the device for mixing and supplying liquid.

The present invention also provides a device for mixing and supplying liquid which continuously circulates the mixed liquid, sprays the mixed liquid through the jet nozzle member, and enables the mixing time of a primarily mixed liquid to be shortened by re-transferring the mixed liquid to a mixing tank unit when the concentration of a mixed liquid does not reach the standard concentration by checking a standard concentration after mixing a plurality of crude liquids supplied from the fixed pressure-maintaining liquid supply part through a jet nozzle member.

In an aspect, a device 1 for mixing and supplying liquid which mixes a plurality of crude liquids having chemical components to obtain a mixed liquid and supplies the mixed liquid to a designated process is provided. The device for mixing and supplying liquid is characterized by including: crude liquid storage tank units 200 which each store the plurality of crude liquids; fixed pressure-maintaining liquid supply parts 100 which selectively supply the crude liquids to a mixing device unit 300 in a state that each of the crude liquids transferred from each of the crude liquid storage tank units 200 is maintained to a predetermined pressure; the mixing device unit 300 which mixes the plurality of crude liquids supplied from the fixed pressure-maintaining liquid supply parts 100; a mixing tank unit 400 which stores a mixed liquid transferred from the mixing device unit 300; a concentration checking unit 500 which checks the concentration amount of a liquid transferred from the mixing tank unit 400; a discharge line unit 600 which discharges a mixed liquid satisfying a preset concentration amount through the concentration checking unit 500; and a circulation line unit 700 which re-transfers a mixed liquid that does not satisfy the preset concentration amount through the concentration checking unit 500 to the mixing tank unit 400.

Further, the fixed pressure-maintaining liquid supply parts 100 is characterized in that a vessel 110 which maintains a predetermined pressure and contains liquid is formed, a main liquid supply means 120 which is fluid-connected to the vessel 110 and supplies an appropriate amount of a predetermined pressure-maintaining liquid to the vessel 110 is formed, a primary pressurization means 130 which is fluid-connected to the vessel 110 and supplies a main nitrogen (N₂) gas maintaining a predetermined fixed pressure to the vessel 110 is formed, a secondary pressurization means 140 which is fluid-connected to the vessel 110 and constantly maintains pressure within the vessel 110 by additionally supplying or exhausting the nitrogen (N₂) gas to fine-tune a differential pressure between a supply pressure and the liquid and a fixed pressure of the main nitrogen (N₂) gas is formed, a level sensor 160 which is installed on the vessel 110 to sense a level of liquid within the vessel 110 is formed, and an output stage pressure maintaining means 170 for constantly maintaining a discharge pressure of liquid discharged from the vessel 110 is formed.

Further, the fixed pressure-maintaining liquid supply parts 100 are characterized by additionally including an overpressure preventing exhaust means 150 for forcibly exhausting the nitrogen (N₂) gas from the vessel 110 to the outside when an abnormal overpressure is sensed within the vessel 110.

Further, the main liquid supply means 120 is characterized by including a first pump 122 for pumping a predetermined pressure maintaining liquid into the vessel 110, a main liquid input stage auto valve 124 which is installed on a first conduit 121 extending between the first pump 122 and the vessel 110, and a main liquid input stage pressure sensor 126.

Further, the primary pressurization means 130 is characterized by including a second pump 132 for pumping a nitrogen (N₂) gas maintaining a predetermined fixed pressure into the vessel 110, a nitrogen gas withdrawing auto valve 134 which is installed on a second conduit 131 extending between the second pump 132 and the vessel 110, and a main nitrogen gas pressure sensor 136.

Further, the secondary pressurization means 140 is characterized by including a third pump 142 for pumping a pressure fine-tuning nitrogen (N₂) gas into the vessel 110, a nitrogen gas supplying auto valve 144 which is installed on a third conduit 141 extending between the third pump 142 and the vessel 110, a fourth pump 148 for pumping a portion of a nitrogen (N2) gas supplied into the vessel 110, and a nitrogen gas exhausting auto valve 146 which is installed on a fourth conduit 145 extending between the fourth pump 148 and the vessel 110.

Further, the output stage pressure maintaining means 170 is characterized by including a fifth pump 172 carrying out a pumping operation to supply a liquid discharge from the vessel 110 to a place of demand, an integrating flow meter 173 which is installed on a fifth conduit 171 extending between the fifth pump 172 and the vessel 110, an output stage auto valve 174, a regulator 175, and an output stage pressure sensor 176.

Further, the mixing tank unit 400 is characterized by including a jet nozzle member 410 which is additionally formed in an inner side thereof to spray a primarily mixed liquid re-transferred to the mixing tank unit 400 through the circulation line unit 700 and shorten the mixing time.

As stated above, a device for mixing and supplying liquid according to the present invention has advantages that the device for mixing and supplying liquid is operated so that a predetermined fixed pressure of a final supply stage is maintained despite the changing pressure due to an external influence of the main supply pressure to enable a plurality of very stable liquids to be mixed and supplied, and increases the operation rate of the equipment to increase an output and improve quality by installing a main nitrogen (N2) gas supply means and a pressure fine-tuning nitrogen (N2) gas pressurization means on a vessel containing a liquid supplied at a variable liquid supply pressure and forming a fixed pressure-maintaining liquid supply part which controls the operation by monitoring pressure inside the vessel in real time in the configuration of the device for mixing and supplying liquid.

Further, a device for mixing and supplying liquid according to the present invention has advantages of spraying the mixed liquid through the jet nozzle member and enabling the mixing time of a primarily mixed liquid to be shortened by re-transferring the mixed liquid to a mixing tank unit when the concentration of a mixed liquid does not reach the standard concentration by checking a standard concentration after mixing crude liquids supplied from the fixed pressure-maintaining liquid supply part.

### BRIEF DESCRIPTION OF THE DRAWINGS

FIG. 1 is a process drawing showing an overall process view of a device for mixing and supplying liquid according to a preferred embodiment of the present invention.

FIG. 2 is a mimetic diagram showing the configuration of a fixed pressure-maintaining liquid supply part in the configuration of a device for mixing and supplying liquid according to a preferred embodiment of the present invention.

FIG. 3 is a schematic block diagram of the fixed pressure-maintaining liquid supply part shown in FIG. 2.

FIG. 4 and FIG. 5 are flowcharts showing a supply method carried out by using the fixed pressure-maintaining liquid supply part in the configuration of a device for mixing and supplying liquid according to a preferred embodiment of the present invention.

### DESCRIPTION OF EXEMPLARY EMBODIMENTS

Hereinafter, a device 1 for mixing and supplying liquid according to an embodiment of the present invention will be described in detail with reference to the accompanying drawings. First of all, it should be paid attention that the same constituent elements or parts in the drawings are indicated by the same reference numerals as far as possible. It should be understood that detailed descriptions of well-known functions and structures related to the present invention will be omitted so as not to unnecessarily obscure the important point of the present invention.

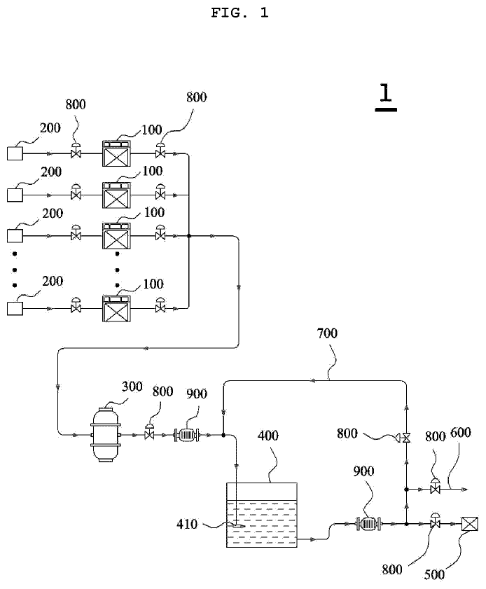

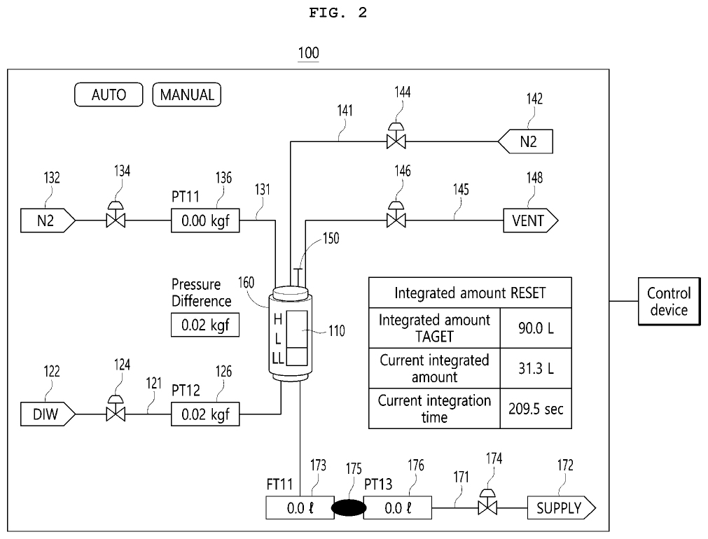

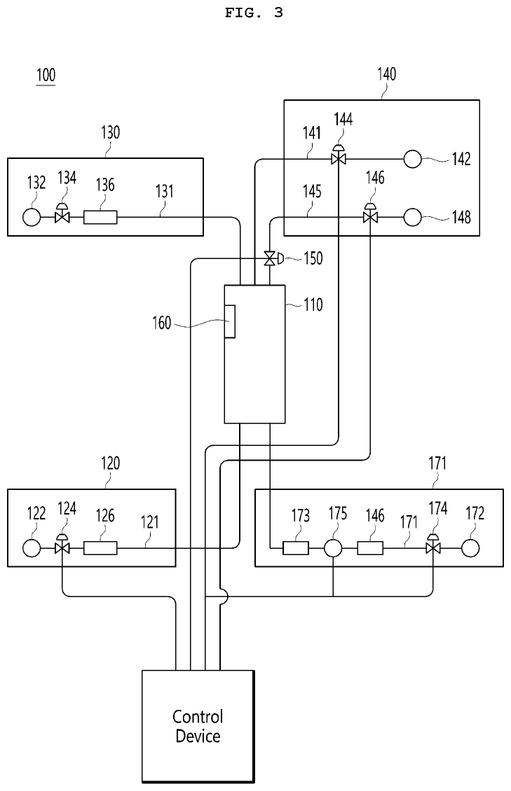

Referring to FIG. 1 or FIG. 2, a device 1 for mixing and supplying liquid according to an embodiment of the present invention is largely comprised of crude liquid storage tank units 200, fixed pressure-maintaining liquid supply parts 100, a mixing device unit 300, a mixing tank unit 400, a concentration checking unit 500, a discharge line unit 600, and a circulation line unit 700.

Prior to the description, in a device 1 for mixing and supplying liquid according to an embodiment of the present invention including interlocking components such as a control unit controlling the entire device 1 for mixing and supplying liquid according to an embodiment of the present invention, a control device controlling the fixed pressure-maintaining liquid supply parts 100, an external power applying device, and the like so that the device for mixing and supplying liquid is smoothly operated, a specific description of the principle will be omitted since a principle of forming and operating the foregoing driving elements corresponds to a technical standard of a level well-known in the art to which the present invention pertains.

Further, it is possible to form pluralities of crude liquid storage tank units 200 and fixed pressure-maintaining liquid supply parts 100 depending on types of crude liquids in the present invention.

First, crude liquid storage tank units 200 are described. The crude liquid storage tank units 200 are components in which a plurality of crude liquids including a sulfuric acid chemical liquid, a hydrogen peroxide chemical liquid, an HF chemical liquid, and the like are each stored as shown in FIG. 1, and the crude liquids stored in the crude liquid storage tank units 200 are provided to respective fixed pressure-maintaining liquid supply parts 100 which will be described later.

Next, fixed pressure-maintaining liquid supply parts 100 are described. The fixed pressure-maintaining liquid supply parts 100, as components which selectively supply the crude liquids to a mixing device unit 300 in a state that each of the crude liquids transferred from the crude liquid storage tank units 200 is maintained to a predetermined pressure, include a vessel 110 which maintains a predetermined pressure and contains liquid, a main liquid supply means 120 which is fluid-connected to the vessel 110 and supplies an appropriate amount of a predetermined pressure-maintaining liquid to the vessel 110, a primary pressurization means 130 which is fluid-connected to the vessel 110 and supplies a main nitrogen (N₂) gas maintaining a predetermined fixed pressure to the vessel 110, a secondary pressurization means 140 which is fluid-connected to the vessel 110 and constantly maintains pressure within the vessel 110 by additionally supplying or exhausting the nitrogen (N₂) gas to fine-tune a differential pressure between a supply pressure and the liquid and a fixed pressure of the main nitrogen (N₂) gas, a level sensor 160 which is installed on the vessel 110 to sense a level of liquid within the vessel 110, and an output stage pressure maintaining means 170 for constantly maintaining a discharge pressure of liquid discharged from the vessel 110.

The main liquid supply means 120 includes a first pump 122 for pumping a predetermined pressure maintaining liquid into the vessel 110, and includes a main liquid input stage auto valve 124 which is installed on a first conduit 121 extending between the first pump 122 and the vessel 110, and a main liquid input stage pressure sensor 126.

The primary pressurization means 130 includes a second pump 132 for pumping a main nitrogen (N2) gas maintaining a predetermined fixed pressure into the vessel 110, and includes a main nitrogen gas pressure sensor 136 which is installed on a second conduit 131 extending between the second pump 132 and the vessel 110.

The secondary pressurization means 140 includes a third pump 142 for pumping a pressure fine-tuning nitrogen (N2) gas into the vessel 110, and includes a nitrogen gas supplying auto valve 144 which is installed on a third conduit 141 extending between the third pump 142 and the vessel 110.

Further, the secondary pressurization means 140 includes a fourth pump 148, an exhaust pump for exhausting a portion of a nitrogen (N2) gas supplied into the vessel 110, and a nitrogen gas exhausting auto valve 146 which is installed on a fourth conduit 145 extending between the fourth pump 148 and the vessel 110.

An overpressure preventing exhaust means 150 is comprised of a relief valve which is installed on a separate conduit (not shown in the drawings) that is fluid-connected to the vessel 110 and extended to the outside, and performs a function of exhausting the nitrogen (N₂) gas to the outside when an overpressure is sensed within the vessel 110 as described earlier.

The output stage pressure maintaining means 170 includes a fifth pump 172 carrying out a pumping operation to supply a liquid discharge from the vessel 110 to a place of demand of a next operation stage, e.g., a mixing chamber (not shown in the drawings), and includes an integrating flow meter 173 which is installed on a fifth conduit 171 extending between the fifth pump 172 and the vessel 110, an output stage auto valve 174, a regulator 175, and an output stage pressure sensor 176.

Hereinafter, a fixed pressure maintaining liquid supply method using the fixed pressure-maintaining liquid supply parts 100 formed as previously stated is described.

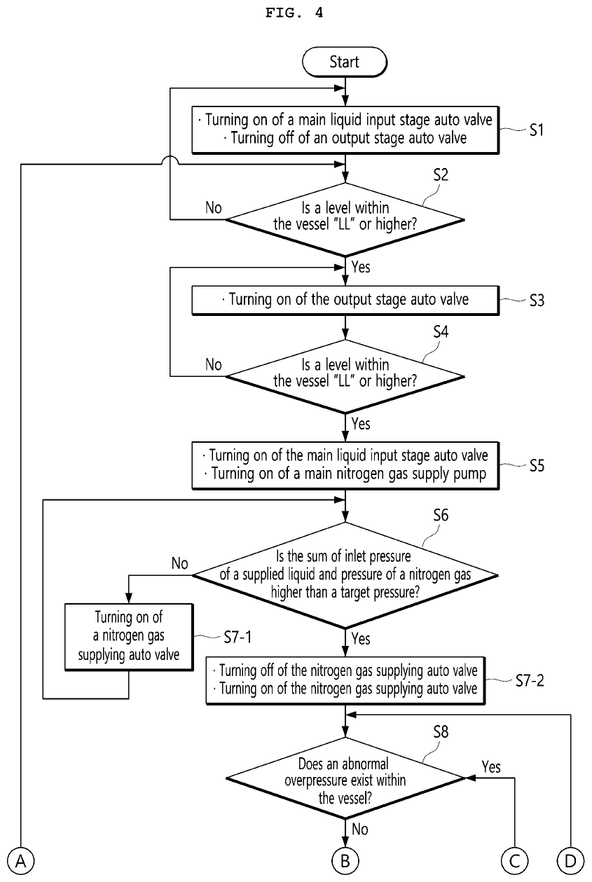

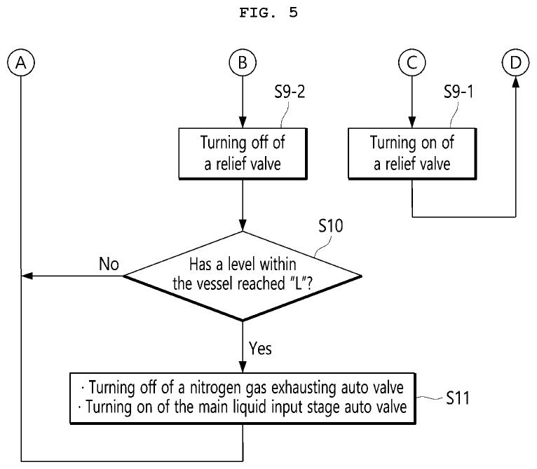

Referring to FIG. 4 and FIG. 5, as mentioned earlier, the vessel 110 plays a role of continuously maintaining a predetermined pressure by containing a liquid introduced at a variable liquid supply pressure, and a pressure within the vessel 110 is set to a desired predetermined pressure so that the vessel 110 plays the role. For example, a target pressure within the vessel 110 may be set to 1 kgf/cm².

For the convenience of explanation, fixed pressure-maintaining liquid supply parts 100 according to the present invention are described from a state that the operation of the fixed pressure-maintaining liquid supply parts is initially initiated.

The main liquid supply means 120 supplies liquid into the vessel 110 at a preset predetermined pressure, for example, a pressure of 0.7 kgf/cm² lower than the target pressure within the vessel 110. That is, the liquid is supplied by operating a first pump 122 of the main liquid supply means 120 according to a signal applied from a control device and opening a main liquid input stage auto valve 124 installed in a downstream of the first pump 122 on a first conduit 121. At this time, a main liquid input stage pressure sensor 126 installed in the downstream of the first pump 122 on the first conduit 121 senses pressure of a liquid supplied from the first pump 122 toward the vessel 110.

A control device allows the liquid to be continuously supplied into the vessel 110 by maintaining a state that the liquid input stage auto valve 124 of the main liquid supply means 120 is continuously opened under the circumstances that supply of liquid toward a mixing chamber (not shown in the drawings) is stopped by turning off the operation of the fifth pump 172 and the output stage auto valve 174 of the output stage pressure maintaining means 170 until a liquid level within the vessel 110 reaches a predetermined level by initiating the operation of the fixed pressure-maintaining liquid supply parts 100 (step S1).

When a level sensor 160 installed on the vessel 110 sends a level sensing signal to a control unit 80 by sensing the liquid level within the vessel 110, a control device determines whether or not the liquid level within the vessel 110 reaches a lowest level LL (step S2).

The control device allows the liquid to be continuously supplied into the vessel 110 by maintaining a state that the liquid input stage auto valve 124 of the main liquid supply means 120 is continuously opened under the circumstances that supply of liquid toward a next operation stage, for example, a mixing chamber (not shown in the drawings), is stopped by turning off the operation of the fifth pump 172 and the output stage auto valve 174 of the output stage pressure maintaining means 170 as in the step Si if the liquid level within the vessel 110 fails to reach the lowest level LL.

If the liquid level within the vessel 110 is increased to the lowest level LL or higher, the output stage auto valve 174 of the output stage pressure maintaining means 170 is operated to maintain an opened state of the output stage auto valve 174, and liquid is supplied from the vessel 110 to the mixing chamber (not shown in the drawings), i.e., the next operation stage accordingly (step S3).

Namely, the control device supplies the liquid from the vessel 110 toward, for example, the mixing chamber (not shown in the drawings) of the next operation stage through the fifth conduit 171 by operating the fifth pump 172 of the output stage pressure maintaining means 170 and opening the output stage auto valve 174. At this time, the integrating flow meter 173 installed on the fifth conduit 171 calculates an appropriate supply amount of a liquid supplied from the vessel 110 to the outside, the regulator 175 maintains the appropriate pressure by adjusting an outlet pressure of the liquid supplied from the vessel 110 to the outside to an appropriate pressure, e.g., 0.7 kgf/cm². The output stage pressure sensor 176 disposed in a downstream of the regulator 175 senses pressure of a discharged liquid to transmit the sensed pressure of the discharge liquid to the control device. Unless the liquid level within the vessel 110 falls below the lowest level LL, such an operation of the output stage pressure maintaining means 170 is always carried out, and allows a liquid maintaining a predetermined fixed pressure to be supplied to a supplied liquid demanding place of the next operation stage.

As the main liquid input stage auto valve 124 continuously is maintained in an opened state, a fixed pressure maintaining liquid is continuously supplied into the vessel 110 by the first pump 122, and the liquid level within the vessel 110 is increased to a low level L or higher accordingly.

Next, when the level sensor 160 installed on the vessel 110 sends a level sensing signal to a control device by sensing the liquid level within the vessel 110, the control device determines whether or not the liquid level within the vessel 110 reaches the highest level H (step S4).

If the liquid level within the vessel 110 does not reach the highest level H, the liquid is continuously supplied to the vessel 110 by continuously maintaining the main liquid input stage auto valve 124 in the opened state as mentioned earlier.

If the liquid level reaches a high level H or higher, the main liquid input stage auto valve 124 is turned off to maintain a closed state according to a signal applied from the control device, and supply of the liquid to the vessel 110 is stopped accordingly. In such a state, a nitrogen (N2) gas with a predetermined fixed pressure is supplied to the vessel 110 by operating the primary pressurization means 130 according to a signal applied from the control device (step S5). That is, the nitrogen (N₂) gas is supplied to the vessel 110 by operating the second pump 132 according to the signal applied from the control device, thereby opening a nitrogen gas withdrawing auto valve 134 installed in a downstream of the second pump 132. At this time, the nitrogen gas pressure sensor 136 installed in a downstream of the nitrogen gas withdrawing auto valve 134 on the second conduit 131 senses pressure of a nitrogen (N₂) gas supplied from the second pump 132 toward the vessel 110.

Meanwhile, the control device additionally supplies a pressure fine-tuning nitrogen (N₂) gas to the vessel 110 or exhaust nitrogen (N₂) gas pressure within the vessel 110 by calculating supply pressure of a liquid transferred from the main liquid input stage pressure sensor 126 and supply pressure of a main nitrogen (N₂) gas transferred from the nitrogen gas pressure sensor 136, thereby operating the secondary pressurization means 140.

Namely, the control device determined whether or not the sum of these pressures is larger than a preset target pressure within the vessel 110 based on the supply pressure of the liquid transferred from the main liquid input stage pressure sensor 126 and the supply pressure of the main nitrogen (N₂) gas transferred from the nitrogen gas pressure sensor 136 (step S6).

If the sum of the supply pressure of the liquid and the supply pressure of the main nitrogen (N₂) gas fails to reach a target pressure within the vessel 110, for example, 1 kgf/cm², the pressure fine-tuning nitrogen (N₂) gas is additionally supplied into the vessel 110 by operating the third pump 142 and opening the nitrogen gas supplying auto valve 144 (step S7-1).

If the sum of the supply pressure of the supplied liquid and the supply pressure of the main nitrogen (N₂) gas exceeds a target pressure within the vessel 110, for example, 1 kgf/cm², the nitrogen (N₂) gas is exhausted from the vessel 110 by turning off the nitrogen gas supplying auto valve 144 to maintain a closed state, operating the fourth pump 148, i.e., an exhaust pump, and opening the nitrogen gas exhausting auto valve 146 (step S7-2).

Separately from the operation of the nitrogen gas exhausting auto valve 146 for exhausting nitrogen (N₂) gas pressure within the vessel 110 to the outside, the control device determines whether or not an excessive overpressure with the extent of exceeding a range capable of being adjusted by the secondary pressurization means 140, i.e., an overpressure corresponding to a preset pressure level, is sensed within the vessel 110 (step S8).

If the excessive overpressure is sensed within the vessel 110, the control device performs a function of forcibly exhausting the nitrogen (N₂) gas to the outside by opening a relief valve 150 (step S9-1).

If the excessive overpressure is not sensed within the vessel 110, the control device maintains the relief valve 150 in a continuously closed state (step S9-2).

Next, the control device determines whether or not a liquid level within the vessel 110 has reached a low level L by an exhaust operation of the nitrogen gas exhausting auto valve 146 (step S10).

If the liquid level has not reached the low level L by allowing the level sensor 160 installed on the vessel 110 to sense the liquid level within the vessel 110, an operation of exhausting the nitrogen (N₂) gas from the vessel 110 by opening the nitrogen gas exhausting auto valve 146 is continuously carried out as previously explained.

If the liquid level has reached the low level L by allowing the level sensor 160 installed on the vessel 110 to sense the liquid level within the vessel 110, the nitrogen gas exhausting auto valve 146 is turned off to maintain a closed state as previously explained. Along with this, supply of the liquid is resumed by opening the liquid input stage auto valve 124 according to a signal applied from the control device (step S11).

That is, the fixed pressure-maintaining liquid supply parts 100 repeatedly perform respective steps in a closed loop form to constantly maintain a supply pressure of liquid (crude liquid) changed by an external influence of the main supply pressure in a final supply stage by cooperative interactions of the primary pressurization means and the pressure fine-tuning nitrogen (N2) gas pressurization means.

Meanwhile, it is preferable that a main line auto valve 800 adjusting flow rate, flow amount, and the like of the crude liquid is further installed on main lines connecting the crude liquid storage tank units 200 and the fixed pressure-maintaining liquid supply parts.

Next, a mixing device unit 300 is described. The mixing device unit 300, as a device which mixes a plurality of crude liquids supplied from the fixed pressure-maintaining liquid supply parts 100 as shown in FIG. 1, can be formed of a plurality of mixing unit forms.

Next, a mixing tank unit 400 is described. The mixing tank unit 400, as a component storing a mixed liquid transferred from the mixing device unit 300 as shown in FIG. 1, has a jet nozzle member 410 formed in an inner side thereof to enable the mixing time of the liquid to be shortened when spraying a primarily mixed liquid re-transferred to the mixing tank unit 400 through a circulation line unit 700 which will be described later.

Meanwhile, it is preferable that the main line auto valve 800 adjusting flow rate, flow amount, and the like of the mixed liquid is further installed on a main line connecting the mixing tank unit 400 and the mixing device unit 300, and it is preferable that a main line pump 900 is also installed thereon to move a predetermined flow amount or more.

Next, a concentration checking unit 500 is described. It is preferable that the main line auto valve 800 adjusting flow rate, flow amount, and the like of the mixed liquid is further installed on a main line connecting the mixing tank unit 400 and the concentration checking unit 500 as a component checking the concentration amount of a liquid transferred from the mixing tank unit 400 as shown in FIG. 1, and it is preferable that the main line pump 900 is also installed thereon to move a predetermined flow amount or more.

Next, a discharge line unit 600 is described. It is preferable that the main line auto valve 800 adjusting flow rate, flow amount, and the like of the mixed liquid is further installed on the discharge line unit 600 as a component which discharges a mixed liquid satisfying a preset concentration amount through the concentration checking unit 500 as shown in FIG. 1 in order to perform a subsequent process.

Next, a circulation line unit 700 is described. It is preferable that the main line auto valve 800 adjusting flow rate, flow amount, and the like of the mixed liquid is further installed on the circulation line unit 700 as a component which re-transfers a primarily mixed liquid that does not satisfy the preset concentration amount through the concentration checking unit 500 to the mixing tank unit 400 as shown in FIG. 1.

Optimal embodiments have been disclosed in the drawings and specification. Although particular terms have been used, these terms have been used for the purpose of only explaining the present invention, but have not been used to restrict meanings of the scope of claims or limit the scope of the present invention described in the scope of claims. Accordingly, a person with ordinary skill in the art shall understand that various modifications and equivalent other embodiments can be made from the scope of the present invention. Therefore, an authentic technical protection scope of the present invention shall be defined by technical ideas of the scope of claims described later.

What is claimed is:

1. A device 1 for mixing and supplying liquid which mixes a plurality of crude liquids having chemical components to obtain a mixed liquid and supplies the mixed liquid to a designated process, the device 1 for mixing and supplying liquid including:
crude liquid storage tank units which each store the plurality of crude liquids;
fixed pressure-maintaining liquid supply parts which selectively supply the crude liquids to a mixing device unit in a state that each of the crude liquids transferred from each of the crude liquid storage tank units is maintained to a predetermined pressure;
the mixing device unit which mixes the plurality of crude liquids supplied from the fixed pressure-maintaining liquid supply parts;
a mixing tank unit which stores a mixed liquid transferred from the mixing device unit;
a concentration checking unit which checks the concentration amount of a liquid transferred from the mixing tank unit;
a discharge line unit which discharges a mixed liquid satisfying a preset concentration amount through the concentration checking unit; and
a circulation line unit which re-transfers a mixed liquid that does not satisfy the preset concentration amount through the concentration checking unit to the mixing tank unit.

2. The device 1 for mixing and supplying liquid of claim 1, wherein the fixed pressure-maintaining liquid supply parts includes a vessel which maintains a predetermined pressure and contains liquid, a main liquid supply means which is fluid-connected to the vessel and supplies an appropriate amount of a predetermined pressure-maintaining liquid to the vessel, a primary pressurization means which is fluid-connected to the vessel and supplies a main nitrogen (N₂) gas maintaining a predetermined fixed pressure to the vessel, a secondary pressurization means which is fluid-connected to the vessel and constantly maintains pressure within the vessel by additionally supplying or exhausting the nitrogen (N₂) gas to fine-tune a differential pressure between a supply pressure and the liquid and a fixed pressure of the main nitrogen (N₂) gas, a level sensor which is installed on the vessel to sense a level of liquid within the vessel, and an output stage pressure maintaining means for constantly maintaining a discharge pressure of liquid discharged from the vessel. cm 3. The device 1 for mixing and supplying liquid of claim 2, wherein the fixed pressure-maintaining liquid supply parts additionally include an overpressure preventing exhaust means for forcibly exhausting the nitrogen (N2) gas from the vessel to the outside when an abnormal overpressure is sensed within the vessel.

4. The device 1 for mixing and supplying liquid of claim 2, wherein the main liquid supply means includes a first pump for pumping a predetermined pressure maintaining liquid into the vessel, a main liquid input stage auto valve which is installed on a first conduit extending between the first pump and the vessel, and a main liquid input stage pressure sensor.

5. The device 1 for mixing and supplying liquid of claim 2, wherein the primary pressurization means includes a second pump for pumping a nitrogen (N2) gas maintaining a predetermined fixed pressure into the vessel, a nitrogen gas withdrawing auto valve which is installed on a second conduit extending between the second pump and the vessel, and a main nitrogen gas pressure sensor.

6. The device 1 for mixing and supplying liquid of claim 2, wherein the secondary pressurization means includes a third pump for pumping a pressure fine-tuning nitrogen (N₂) gas into the vessel, a nitrogen gas supplying auto valve which is installed on a third conduit extending between the third pump and the vessel, a fourth pump for pumping a portion of a nitrogen (N2) gas supplied into the vessel, and a nitrogen gas exhausting auto valve which is installed on a fourth conduit extending between the fourth pump and the vessel.

7. The device 1 for mixing and supplying liquid of claim 2, wherein the output stage pressure maintaining means includes a fifth pump carrying out a pumping operation to supply a liquid discharge from the vessel to a place of demand, an integrating flow meter which is installed on a fifth conduit extending between the fifth pump and the vessel, an output stage auto valve, a regulator, and an output stage pressure sensor.

8. The device 1 for mixing and supplying liquid of claim 1, wherein the mixing tank unit includes a jet nozzle member which is additionally formed in an inner side thereof to spray a primarily mixed liquid re-transferred to the mixing tank unit through the circulation line unit and shorten the mixing time.
